(19) United States
(12) Patent Application Publication
(10) Pub. No.: US 2012/0084635 A1
(43) Pub. Date: Apr. 5, 2012

(54) PARAMETERIZED TEMPLATE COMPRESSION FOR BINARY XML

(75) Inventor: Nicholas Allen, Redmond, WA (US)

(73) Assignee: MICROSOFT CORPORATION, Redmond, WA (US)

(21) Appl. No.: 12/894,408

(22) Filed: Sep. 30, 2010

(51) Int. Cl. G06F 17/00

(52) U.S. Cl. 715/234

(57) ABSTRACT

Compression and decompression of XML and other structured documents uses parameterized templates. A region of a serialized document is nominated as a template, information units are annotated as fixed or parameter values, and the template is recorded with a template identifier. A template invocation represents the nominated records. Nominated regions can be nested, and they do not necessarily correspond to XML elements or other well-formed portions of the original document. Templates may be defined on the fly, after compression has started.

### BACKGROUND

In computer science, compression is the practice of representing data in a more compact form by reducing the amount of redundant information that is included when data is stored or communicated. Lossless compression is a kind of compression in which the original data can be exactly recovered from the compressed data, that is, from the data in the reduced format. Lossless compression can be useful when even small changes to the data may significantly change the meaning of the data.

Various resource tradeoffs may arise in conjunction with compression. For example, significant gains in coding efficiency (that is, in the relative reduction in size of the data) may require inordinate expenditures of limited computational resources. More generally, the various advantages and costs of compression can be viewed in a context of overall resources and objectives that varies according to the circumstances.

Compression may be applied to various kinds of data. In particular, compression may be applied to structured documents which are normally human-legible, such as XML documents. XML provides a set of rules for the electronic encoding of documents, which are sometimes used in protocols for exchanging structured information in the implementation of web services, for example. Lossless compression may allow such documents to be exchanged with improved coding efficiency and without changing their meaning. Within an XML document it is common to have repetitive sequences where portions of the document have a high structural similarity but contain different data. These repetitive sequences are particularly common in XML documents that encode data collections, lists, tables, query results, or batches. In general, repetition indicates that compression of some kind may be worth considering. As with compression generally, however, the resources and objectives of XML document compression may differ according to the circumstances, so having a variety of possible approaches can be helpful.

### SUMMARY

Templatization is a compression method that separates structure from instance values so that a structural description may be encoded once rather than repeating it for each instance. However, in many data processing situations it is difficult to identify structural descriptions sufficiently far in advance to make use of this templatization.

Nonetheless, some embodiments described herein provide compression and decompression of structured documents (particularly XML documents) using parameterized templates. For example, in some embodiments a sequence of compressed automatically parsable document(s) in a memory has records which include literal data and also includes compression records. A template nomination record nominates a region of the records as a parameterized template. A literal information unit may be annotated with an annotation record within the nominated region, e.g., to mark literal information as parameter value(s). A template invocation record contains an invocation of the parameterized template. A template identifier in the template invocation record is consistent with identifiers generated by a local template identifier generator. A document compressor generates the compressed document(s) using the template identifier generator, and a document decompressor decompresses the compressed document(s), also in conjunction with the template identifier generator.

Nominated regions used in such compression/decompression have various characteristics. For instance, they do not necessarily correspond to well-formed portions of the original document under the applicable syntax, e.g., under XML syntax. In some embodiments, an inner nomination region is nested within an outer nomination region. In some, an invocation of a first template occurs within a nomination region of a second template. In some, records defining a template structure layout for the template are interleaved in the memory with an instance of the template, the template nomination record, and the literal information unit annotation record.

In some embodiments, compression of an XML document (for example) includes nominating a region of the XML document for production as a parameterized template, inserting at least one record in the document to effect the nomination, and annotating at least one literal information unit within the nominated region. Then a template identifier is generated, by using a successor function, a hash function, and/or a user-defined identifier provided as a field of a nomination record, for example. A parameterized template for the nominated region is recorded in a template collection, in correspondence with the template identifier. The recorded template is then invoked in the XML document, with different parameter values potentially being passed in different invocations for a given parameter of the recorded template.

In some embodiments, compression records include nomination records. A nomination record may do any of the following in some embodiments, while in other embodiments only a subset of these nominating effects are available: nominate an upcoming complete XML element, nominate a most recently completed XML element, nominate a specific number (one or more) of upcoming information units, nominate a specific number (one or more) of preceding information units. In some embodiments, records may also be used to specify an information unit group start and/or end. Some embodiments record a template structure layout and also record a fixed information unit and/or a position of a parameter information unit.

In some embodiments, compression records include annotation records. An annotation record may do any of the following in some embodiments, while in other embodiments only a subset of these annotating effects are available: mark upcoming literal information unit(s) as fixed value(s), mark upcoming literal information unit(s) as parameter value(s), mark preceding literal information unit(s) as fixed value(s), mark preceding literal information unit(s) as parameter value(s), set a default disposition of literal information unit(s) within the template as fixed value(s), set a default disposition of literal information unit(s) within the template as parameter value(s), provide a literal information unit and also mark that unit as a fixed value, provide a literal information unit and also mark that unit as a parameter value.

In some embodiments, decompression of an XML document (for example) includes receiving at least one record which nominates a region of a document as containing parameterized template information, and automatically parsing the nominated region, thereby extracting nominated region parsing results. In some embodiments, extracted parsing results include at least one parameter, and may include a template structure layout, a fixed information unit, and a position of a parameter information unit. As with compression, a region of the document being decompressed may be recognizable by automatic parsing as being a fragment rather than being a well-formed region under an original syntax.

Continuing the decompression, a template identifier is generated, using another instance of the same mechanism that was used during compression, so that template identifiers match even when compression and decompression are separated in space and time. A template is recorded by adding the nominated region parsing results to a template collection in a correspondence with the template identifier. A first invocation record contains a first invocation of the recorded template, including a recital of the template identifier and a first parameter value. Subsequent invocation records may contain other invocations of the recorded template, possibly with different parameter values. In some cases, a parameter type is inferred from the recorded template and in other cases parameter type is expressly provided.

In some embodiments, during decompression the nominated region is located in the document after at least one initial uncompressed record of the document. Thus, at least one initial uncompressed record of the document is received before the record(s) which nominate a region of the document as containing template information.

In some embodiments, the document invokes a first template from within a region defining a second template. That is, a record which contains an invocation of the recorded template is also within a second nominated region.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, at least one document subject to compression, and other items in an operating environment which may be present on multiple network nodes, and also illustrating configured storage medium embodiments;

FIG. 2 is a block diagram illustrating compression using parameterized templates and fragment regions, in an example architecture;

FIG. 3 is a flow chart illustrating steps of some process and configured storage medium embodiments;

FIG. 4 is a data flow diagram further illustrating some embodiments, with particular attention to XML document compression; and

FIGS. 5 and 6 collectively illustrate a sequence of records from an example of XML document compression.

### DETAILED DESCRIPTION

### Overview

XML (eXtensible Markup Language) and XML-based mechanisms such as Simple Object Access Protocol (SOAP) can be used to facilitate web services. Through the exchange of XML-related messages, for example, web services can describe their capabilities and allow other services, applications or devices to easily invoke those capabilities. One familiar use of XML is the exchange of data between different entities, such as client and server computers, in the form of requests and responses. The contents of these requests and responses are in the form of XML documents, namely, sequences of characters that comply with the specification of XML. For example, SOAP provides an open and extensible way for applications to communicate over the web using XML-based messages, regardless of what operating system, object model, or language the particular applications may use.

XML syntax supports definition of tags and of structural relationships between tags. XML documents can impose constraints on storage layout and logical structure, while still providing great flexibility in message content. In an XML document, start and end tags can be nested within other start and end tags, defining a tree-like structure of XML elements. Subtrees in which start and end tags match up delimit well-formed regions of the XML document. An XML infoset is an abstract representation of an XML document. An infoset includes information items, and can be viewed as the information content of the XML document, without restriction on the document's format.

For transmission or storage, textual XML can be encoded into bytes that represent the corresponding text. Some text conversion standards include ASCII Unicode, UTF8 and UTF16. An in-memory representation of an XML infoset can be serialized into a textual XML string. Then the characters of the textual string can be encoded into corresponding bytes for transmission. In the reverse process, the received textual-related XML bytes are decoded into the corresponding textual XML string, which is de-serialized and stored to provide an in-memory representation of the XML infoset. The in-memory representation of an XML infoset exists logically, but need not exist physically as XML data prior to serialization.

Although XML information items can be easily serialized in this manner, and provide human-legible text, as a practical matter such serialized documents can be verbose and inefficient for processing. In some cases, accordingly, various now familiar approaches are used to serialize XML documents into a binary format, e.g., through use of a dictionary that associates information items with binary-data unit identifiers. The identifiers may identify known strings, repeated strings, repeated structures, primitive types, and/or constructs, for example. Some approaches to binary XML use static and/or dynamic dictionaries. Some approaches trade the human readability and verbosity of standard XML for improvements in serialized document size, parsing, and generation speed. Some reduce or eliminate redundant information in an XML encoding/decoding process. As with compression generally, however, the resources and objectives pertaining to XML compression in conjunction with binary encoding may differ according to the circumstances, so having a variety of possible approaches can be helpful.

Some embodiments described herein may be viewed in a broader context. For instance, concepts such as compression, parsing, templates, parameters, and identifiers may be relevant to a particular embodiment. However, it does not follow from the availability of a broad context that exclusive rights are being sought herein for abstract ideas; they are not. Rather, the present disclosure is focused on providing appropriately specific embodiments. Other media, systems, and processes involving compression, parsing, templates, parameters, and/or identifiers are outside the present scope. Accordingly, vagueness and accompanying proof problems are also avoided under a proper understanding of the present disclosure.

Some embodiments described herein process an XML document stream by first translating the document into a series of information units that can be encoded using a binary record structure. The stream producer nominates a portion of the document to have its structural description recorded for later use. The nomination is effected by the inclusion of one or more records in the binary record structure intermixed with the records providing the initial instance values. From the initial instance, a template is produced that includes a parameterized sequence of information units and a template identifier. The producer of the document later uses the template identifier to refer to the structural description, to more efficiently encode subsequent portions of the document that share the same structure. Element templates may have a scoped lifetime which does not necessarily coincide with scopes of well-formed regions in the original unprocessed document.

In some embodiments, definition of dynamic structural layout templates occurs subsequent to the start of document encoding. Some embodiments interleave the definition of the template structure layout with the first template instance through nominating records and information unit annotations. Some record a template from a fragmentary region that does not correspond to a full well-formed portion of the document (e.g., under XML syntax). Some embodiments can invoke a first template from within a region defining a second template. Some can infer a typed data contract from the template example to more compactly specify parameter values at invocation. Other features discussed herein may also be present in a given embodiment.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventor asserts and exercises his right to his own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine. However, “automatically” does not necessarily mean “immediately”.

Throughout this document, use of the optional plural “(s)” means that one or more of the indicated feature is present. For example, “parameter(s)” means “one or more parameters” or equivalently “at least one parameter”.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as “transmitting”, “sending”, “communicating”, “recording”, “inserting”, “annotating”, “marking”, “setting”, or other action with reference to a target or destination may involve intervening action such as forwarding, copying, uploading, downloading, encoding, decoding, compressing, decompressing, encrypting, decrypting and so on by some other party, yet still be understood as being performed directly by the party of interest.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

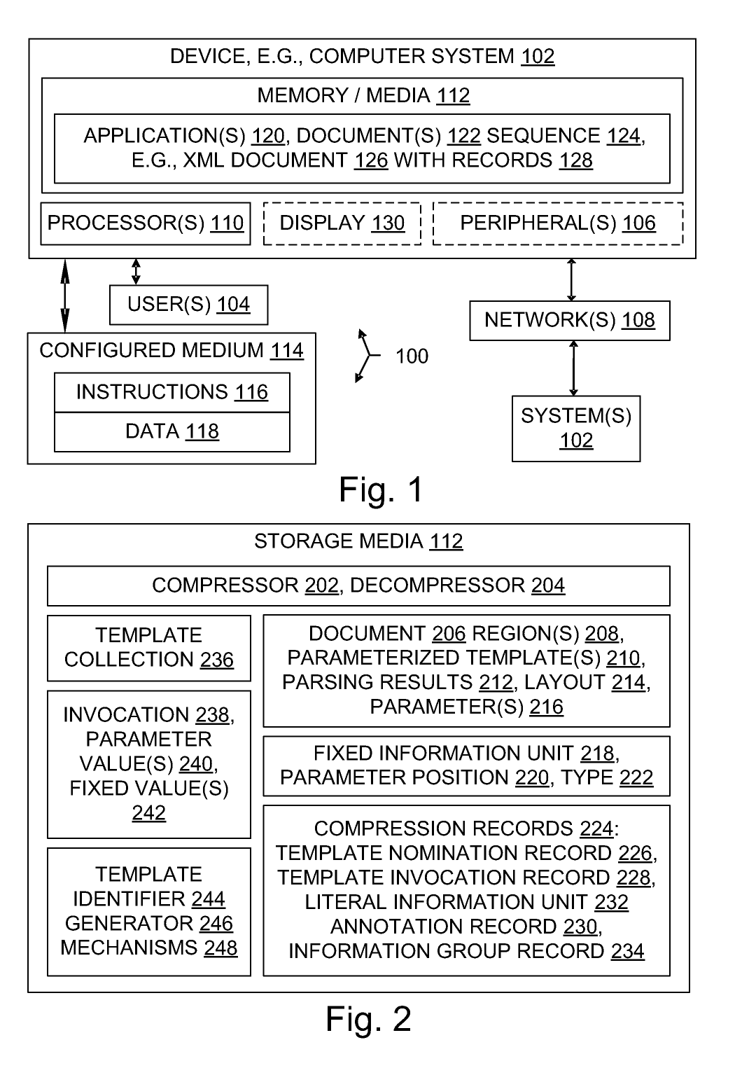

With reference to FIG. 1, an operating environment 100 for an embodiment may include computer system(s) 102, and in particular may include two or more computer systems 102 which communicate using XML and/or other structured documents. A given computer system 102 may be a multiprocessor computer system, or not. An operating environment may include one or more machines in a given computer system, which may be clustered, client-server networked, and/or peer-to-peer networked.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system(s) 102 or with another system embodiment, by using one or more connections to a network 108 via network interface equipment, for example.

The computer system 102 includes at least one logical processor 110. The computer system 102, like other suitable systems, also includes one or more computer-readable non-transitory storage media 112. Media 112 may be of different physical types. The media 112 may be volatile memory, non-volatile memory, fixed in place media, removable media, magnetic media, optical media, and/or of other types of non-transitory media (as opposed to transitory media such as a wire that merely propagates a signal). In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by compression/decompression as discussed herein, e.g., by recording, annotation, parsing, invocation, templatization, binding, deployment, execution, modification, display, creation, loading, and/or other operations.

Application(s) 120 generate, send, receive, and/or otherwise utilize document(s) 122, that is, a sequence 124 of one or more documents 122. Documents 122 may include XML documents 126 with constituent records 128, for example. Applications 120, documents 122, and other items shown in the Figures and/or discussed in the text may reside partially or entirely within one or more media 112, thereby configuring those media. In addition to the processor(s) 110 and memory 112, an operating environment may also include other hardware, such as a display 130, buses, power supplies, and accelerators, for instance.

One or more items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

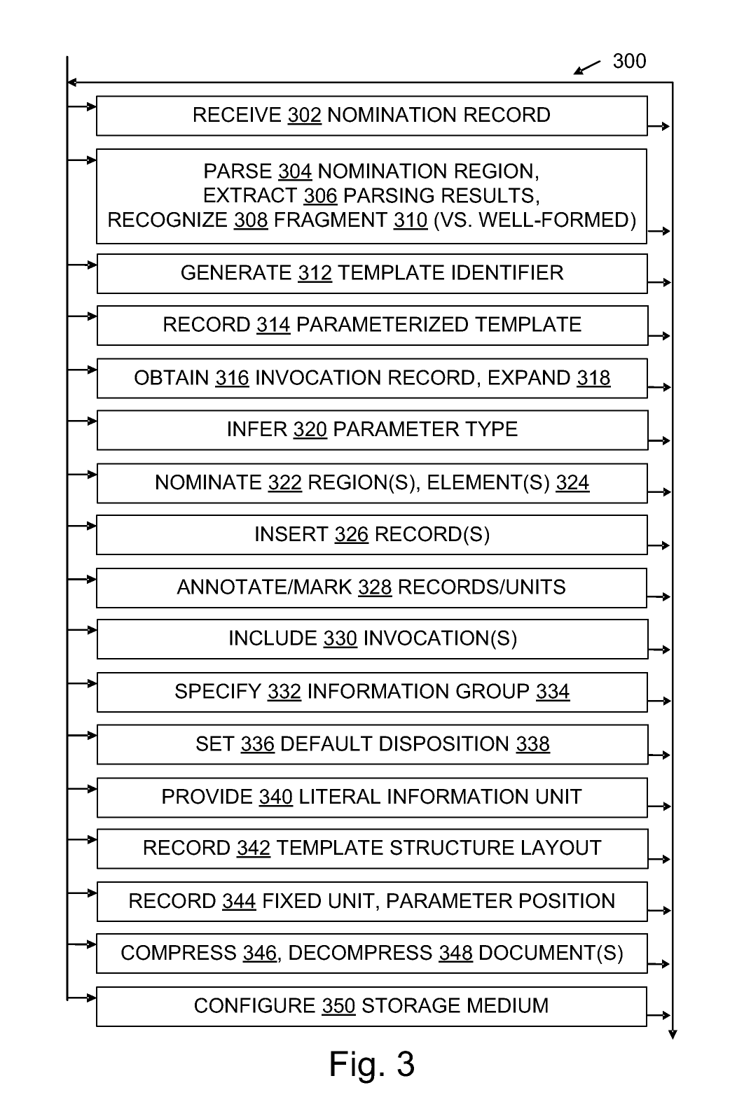

FIG. 2 illustrates an architecture which is suitable for use with some embodiments. The illustrated architecture includes both a compressor 202 and a decompressor 204, but in some embodiments only a compressor 202 is present, and in some only a decompressor 204 is present. The compressor 202 and decompressor 204 generate, send, and/or receive encodings of documents 122, which are also referred to as “documents” but are designated herein as document(s) 206 to reflect the presence of at least partial compression by a compressor 202.

In some embodiments, documents 206 have regions 208, which do not necessarily correspond with well-formed regions of the original documents 126. Rather, the regions 208 are nominated as part of the compression process. Documents 206 also have (or equivalently, are associated with) parameterized templates 210, parsing results 212, layout 214, and parameter(s) 216. In connection with compression, and in particular in conjunction with parameters 216 and parameterized templates 210, documents 206 have records that contain or otherwise specify fixed information unit(s) 218 (e.g., XML infoset data), parameter position(s) 220, and parameter type(s) 222.

In some embodiments, documents 206 are implemented using a mix of familiar records 128 and compression records 224. For example, compression records 224 may include template nomination records 226, template invocation records 228, annotation records 230 (which annotate literal information units 232), and information group records 234. Related information may be recorded in a template collection 236. Depending on their role in a given situation, compression records 224 may contain template invocations 238, parameter values 240, and fixed values 242. Template identifiers 244 in compression records 224 are provided by a template identifier generator 246 which uses one or more template identifier generation mechanisms 248.

With reference to FIGS. 1 and 2, some embodiments provide a computer system 102 with a logical processor 110 and a memory medium 112 configured by circuitry, firmware, and/or software to transform a document 122, 206 by compression and/or decompression as described herein. A template identifier generator 246 is in a functional relationship with the logical processor and the memory. The memory is in operable communication with the logical processor. A sequence of compressed automatically parsable document(s) 206 resides in the memory. The documents 206 have records 128, 224 which include (a) at least one template nomination record 226 nominating a region 208 of the records as a parameterized template 210, (b) at least one literal information unit annotation record 230 within the nominated region, (c) at least one template invocation record 228 for an invocation of the parameterized template, and (d) at least one record 230 marking literal information unit(s) as parameter value(s) 240 for the invocation of the parameterized template. The template invocation record contains a template identifier 244 which identifies the template and is consistent with identifiers generated by the template identifier generator 246. Consistent identifiers are those generated by using the same generator or a functionally equivalent mechanism 248 so identifiers match across compression—decompression, for example.

Some embodiments include a document compressor 202 which is configured to generate the compressed automatically parsable document(s) in conjunction with the template identifier generator. Some include a document decompressor 204 which is configured to decompress the compressed automatically parsable document(s) in conjunction with the template identifier generator.

In some embodiments, the sequence of compressed automatically parsable document(s) includes an inner nomination region 208 nested within an outer nomination region 208. In some, an invocation 238 of one template 210 is present within a nomination region 208 of another template 210. As noted, in some embodiments the sequence of compressed automatically parsable document(s) includes a nomination region 208 which is not well-formed under a syntax with which the document(s) 122 as a whole comply. In some embodiments, records 224 defining a template structure layout 214 for the template are interleaved in the memory with an instance of the template, the template nomination record, and the literal information unit annotation record.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a system, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Some embodiments operate in a “cloud” computing environment and/or a “cloud” storage environment. For example, a compressor 202 may be on one device/system 102 in a networked cloud, a decompressor 204 may be on another device/system within the cloud, and the compressed documents 206 may configure the memory on these and other cloud device(s)/system(s) 102, such as intervening server computers, routers, bridges, and so on.

Processes

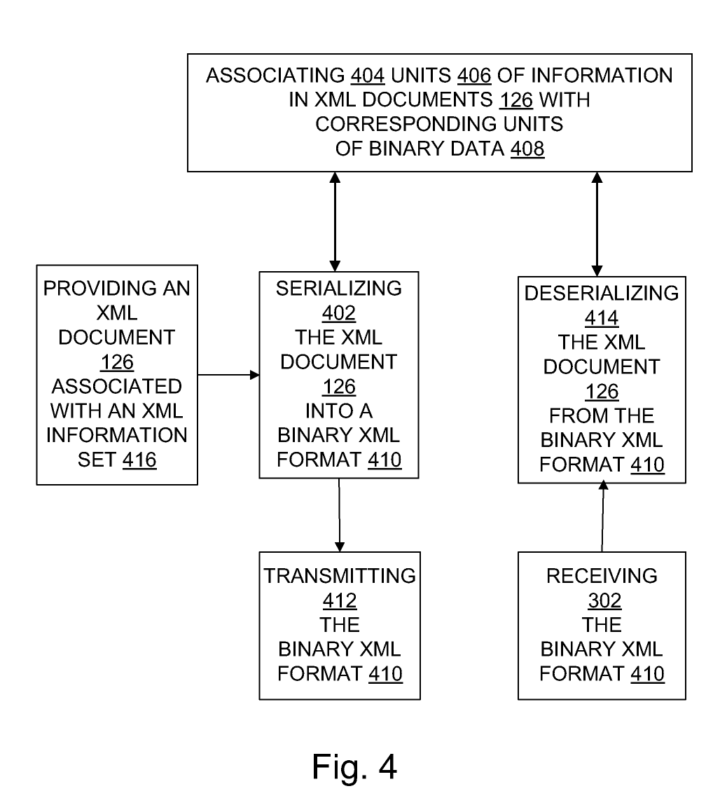

FIG. 3 illustrates some process embodiments in a flowchart 300. Processes shown in the Figures may be performed in some embodiments automatically, e.g., by a compressor 202 and/or decompressor 204 under control of an application, a network stack, or a kernel. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During a nomination record receiving step 302, an embodiment receives a nomination record 226 which identifies a nominated region 208. Other record receiving steps are also denoted as step 302 herein, e.g., receiving 302 an invocation record 228. Step 302 may be accomplished using network transmission, file system reads, RAM access, and/or other familiar mechanisms adapted by virtue of acting upon nomination record(s) 226 and/or other records, for example.

During a nominated region parsing step 304, an embodiment parses a nominated region 208. Parsing 304 may identify literal information unit(s) 232, parameter(s) 216, annotation record(s) 230, additional nomination record(s) 226, and/or other parsing results 212, as taught by examples and discussion herein, for example. Particular parsing results 212 of interest, such as those implementing parameterized templates, may be extracted 306 during parsing 304 of a sequence containing records 128, 224. Parsing may explicitly or implicitly recognize 308 that a nomination region 208 is a fragment 310 with regard to the original document's syntax, e.g., under SOAP or XML syntax. Implicit recognition 308 occurs when parsing results span a region 208 that is not well-formed in terms of XML start-end tag pairs, for example. Parsing 304 may be accomplished using lexical analysis, pointers, syntactic and semantic analysis, and other familiar mechanisms, for example, which have been adapted to recognize and process compression records 224 and to otherwise perform as taught herein.

During a template identifier generating step 312, an embodiment generates a template identifier 244. Template identifiers generated 312 during compression of a given document 122 should match the template identifiers generated during decompression of that document, that is, the sequence of identifiers 244 is shared by the compression and the decompression for a given document. Template generators 246 may be implemented by code inside a compressor 202 and other code inside a decompressor 204. However, template identifier generation 312 can also be viewed as a logically distinguishable part of compression and (likewise) of decompression, as suggested by FIG. 2, and thus a system could be implemented in which a compressor 202 and a decompressor 204 both use the same code to generate 312 template identifiers 244. A given shared sequence of template identifiers 244 may be generated 312 using familiar mechanisms 248 such as a successor function, a hash function, or a user-defined identifier, adapted by virtue of their use in the specific compression and/or decompression processes taught herein.

During a parameterized template recording step 314, an embodiment records a parameterized template 210 in a table or other data structure in a template collection 236. The details of the template 210 are provided by the parsing results 212 and the context of the recording 314. The template 210 is recorded 314 in correspondence with a template identifier 244 that is (or was) generated 312 to identify the template 210 that is being recorded 314.

During an invocation record obtaining step 316, an embodiment obtains a template invocation record 228. The invocation record 228 may be obtained 316 while parsing 304 a nomination region, for example.

During an invocation record expanding step 318, an embodiment expands a template invocation record 228, and in particular, may expand an invocation 238 of a parameterized template 210 by inserting parameter value(s) 240 and by replicating record(s) based on the template 210, for example. Expanding 318 decompresses a document by replacing a template invocation with records that match an uncompressed region of the document that was nominated to be represented by the template invocation.

During a parameter type inferring step 320, an embodiment infers a parameter's data type from context, such as by using a default type when no other type is explicitly given, or by using the most recently explicitly stated type when no other type is explicitly given.

During a region nominating step 322, an embodiment nominates a region 208 as a region containing information about a parameterized template 210. For instance, the information may include records 128 which will be repeated when the template 210 is expanded 318, or parameter values 240 that will be supplied when the template 210 is expanded 318. Region nomination may be effected in various ways, e.g., by records 226 which specify prior or upcoming XML elements 324, or specify a given number of prior or upcoming records, as belonging to the nominated region 208.

During a record inserting step 326, an embodiment inserts records 128, 224. For example, compression record(s) 224 may be inserted 326 in a stream of records while compressing a document. Likewise, copies of original data records 128 may be created and inserted 326 while expanding 318 an invoked template 210 during decompression of a document.

During an annotating step 328, which is also referred to herein as a marking step 328, an embodiment inserts records 224 to annotate, or otherwise marks, information in a document. For example, during compression literal information units in a document may be marked 328 as fixed values 242 or as parameter values 240, for purposes of a surrounding region nominated 322 as a template region 208.

During an invocation including step 330, an embodiment includes an invocation 238 of a parameterized template 210 in a compression of a document, rather than including a complete copy of the nominated region 208 of the original document. For example, an invocation record 228 containing the invocation may be inserted 326 in the stream or other sequence of records 128, 224 that define the document that is being (or has been) compressed.

During an information group specifying step 332, an embodiment specifies an information group 334, e.g., by specifying the group's start, the group's end, or both. An information group 334 is a group of two or more information units 218, such as literal information units 232 or annotated units 232, for example.

During a default setting step 336, an embodiment sets a default disposition 338 of literal information units, e.g., to prospectively mark them as fixed values, or as parameter values, unless an explicit indication otherwise is made to override the default disposition.

During a literal information unit providing step, an embodiment provides literal information unit(s) 232, as part of a document which is being compressed or decompressed. Mechanisms such as those used to receive 302 (or similarly, to send) records can be used to provide records containing literal information.

During a layout recording step 342, an embodiment records in a table or other data structure a layout 214 of a template 210. For example, a copy of the template may be recorded, with indications denoting fixed values 242, parameters 216, and original document syntax records, in their respective positions in the stream or other sequence of records 128, 224. Step 342 may be part of template recording step 314.

During a details recording step 344, an embodiment records details of a template 210 in a table or other data structure. For example, fixed information units 218, parameter position 220 within a template, and parameter types 222 may be recorded 344. Step 344 may be part of template recording step 314.

During a compressing step 346, an embodiment compresses a document 122, using steps such as generating 312, nominating 322, inserting 326, annotating 328, including 330, specifying 332, setting 336, providing 340, and/or recording 342, 344, for example.

During a decompressing step 348, an embodiment decompresses a document 206, using steps such as receiving 302, parsing 304, extracting 306, recognizing 308, generating 312, recording 314, obtaining 316, expanding 318, inferring 320, nominating 322, inserting 326, and/or setting 336, for example.

During a memory configuring step 350, a memory medium 112 is configured by a compressed or partially compressed document 206, a parameterized template 210, compression record(s) 224, or otherwise in connection with templated fragment compression of binary documents as discussed herein.

The foregoing steps and their interrelationships are discussed in greater detail below, in connection with various embodiments.

Some embodiments provide a process for decompressing a sequence of previously created and compressed automatically parsable document(s) 206 containing records 128, 224. At least one record 226 which nominates a region 208 of a document as containing parameterized template 210 information is received 302. The nominated region is automatically parsed 304, thereby extracting 306 nominated region parsing results 212 which include at least one parameter 216. A template identifier 244 is generated 312. A template 210 is recorded 314, by adding the nominated region parsing results to a template collection 236 in correspondence with the template identifier.

Continuing this process, a first invocation record 228, which contains a first invocation 238 of the recorded template, is obtained 316. The first invocation contains a recital of the template identifier 244 and a first parameter value 240. The recital of the template identifier 244 may be explicit, such as by including the template identifier with the template invocation record, or may be implicit. For example, a record may be both a nomination record 226 and a template invocation record 228, wherein the template identifier 244 of the template invocation record implicitly is the generated 312 template identifier corresponding to the nomination record. A second invocation record 228, which contains a second invocation of the same recorded template 210, is also obtained 316. The second invocation contains a recital of the same template identifier and also contains a second parameter value for the parameter, which differs from the first parameter value for the same parameter. The invocations of the recorded template are expanded 318. In some embodiments, the process infers 320 a parameter type from the recorded template.

The terms “first” and “second” are used here merely to differentiate the invocations, not to indicate the number of invocations encountered. The parsing 304 may have encountered intervening invocations and/or prior invocations, as well as the first and second invocations.

In some embodiments, the process extracts 306 nominated region parsing results 212 which include a template structure layout 214 and which also include at least one of the following: a fixed information unit 218, a position 220 of a parameter 216 information unit.

In some embodiments, the process generates 312 the template identifier using at least one of the following mechanisms 248: a successor function, a hash function, a user-defined identifier provided as a field of a nomination record.

In some embodiments, the sequence includes an XML document 126, and the process receives 302 at least one record 226 which nominates a region of the XML document. In some, the process receives 302 at least one record 226 which nominates a region 208 of the document which is recognizable 308 by automatic parsing as being a fragment 310 rather than being a well-formed region.

In some embodiments, the nominated region 208 is located in the document after at least one initial uncompressed record 128 of the document, and the process also receives 302 at least one initial uncompressed record of the document before receiving 302 the record(s) 226 which nominate a region of the document as containing template information. That is, templates 210 may be defined partway into the compression, and thus be received by the decompressor after some initial uncompressed record(s) 128.

In some embodiments, the document invokes a first template from within a region defining a second template, in the sense that the process obtains 316 a record 228 which (a) contains an invocation of the recorded template and (b) is also within a second nominated region. In some, the XML document 206 includes a record 228 containing a template invocation that specifies the generated template identifier 244 to use.

Some embodiments provide a process for compressing a document 122. A region of the XML document or other document is nominated 322 for production to the compressor as a parameterized template 210. The region is not necessarily well-formed under XML syntax. At least one record 226 is inserted 326 in the document to effect the nomination. At least one literal information unit 232 within the nominated region 208 is annotated 328. A template identifier 244 is generated 312. A parameterized template 210 for the nominated region 208 is recorded 314 in a template collection 236, in correspondence with the template identifier. Invocations 238 of the recorded template are inserted 326 in the document, with different parameter values 240 to be passed for a given parameter of the recorded template in the different invocations.

In particular, in some embodiments at least one of the following is inserted 326 in the document to effect the nomination: a record 226 nominating an upcoming complete XML element, a record 226 nominating a most recently completed XML element, a record 226 nominating a specific number of upcoming information units, a record 226 nominating a specific number of preceding information units, a record 234 specifying an information unit group 334 start, a record 234 specifying an information unit group 334 end.

In particular, in some embodiments annotating 328 includes inserting 326 at least one of the following in the document: a record 230 marking upcoming literal information unit(s) as fixed value(s) 242, a record 230 marking upcoming literal information unit(s) as parameter value(s) 240, a record 230 marking preceding literal information unit(s) as fixed value(s), a record 230 marking preceding literal information unit(s) as parameter value(s), a record 224 setting 336 a default disposition of literal information unit(s) within the template (in the nominated region) as fixed value(s), a record 224 setting 336 a default disposition of literal information unit(s) within the template as parameter value(s), a record 230 providing 340 a literal information unit and also marking that unit as a fixed value, a record 230 providing 340 a literal information unit and also marking that unit as a parameter value.

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as a compressor 202, a decompressor 204, a partially or fully compressed document 206, and/or a parameterized template 210 which is a fragment 310, in the form of data 118 and instructions 116, read from a removable medium 114 and/or another source such as a network connection, to form a configured medium. The configured medium 112 is capable of causing a computer system to perform process steps for transforming data through compression and/or decompression as disclosed herein. The Figures thus help illustrate configured storage media embodiments and process embodiments, as well as system and process embodiments. In particular, any of the process steps illustrated in FIG. 3, or otherwise taught herein, may be used to help configure a storage medium to form a configured medium embodiment.

### Additional Examples

Additional details and design considerations are provided below. As with the other examples herein, the features described may be used individually and/or in combination, or not at all, in a given embodiment.

Those of skill will understand that implementation details may pertain to specific code, such as specific APIs and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

Consider the following short XML document fragment that spells out a common portion of messages enveloped using the SOAP protocol for exchange by web services.

<5:Envelope xmlns:s=“http://www.w3.org/2003/05/soap-envelope”></s:Envelope>

The domain name and other address information in this XML document is meant solely as an example, and in particular is not intended to incorporate by reference any information located outside the present patent document. The same is also true of all other instances of domain names in this patent document.

One way to represent this XML document is by coding each of the characters in the document using a textual character set representation. For example, in ASCII the character ‘<’ is 0x3C, the character ‘s’ is 0x73, and so on.

A more compact representation of the same XML document may be obtained by coding the document using structurally semantic records. For example, a byte sequence may be defined that represents an XML element, an XML attribute, and so on, combined with the ability to describe a standard set of primitive types.

As an example, the above XML document may be represented with the following sequence of records:

### StartElement

### ElementName ‘Envelope’

### ElementPrefix ‘s’

### DeclareNamespace

### NamespaceName ‘s’

NamespaceValue ‘http://www.w3.org/2003/05/soap-envelope’

### EndElement

Various record formats may be chosen to improve the coding efficiency of the binary format. For example, if the sequence of StartElement and ElementPrefix records was particularly common it might be combined into a single StartElementPrefixedWithS record. Defining a single record that represents a combination of records is an example of creating a static template. A template encodes several information units in the document in a fixed fashion while allowing other information units to be determined as part of the application of the template.

For example, the StartElementPrefixedWithS record would represent the information units

### StartElement

### ElementName #1

### ElementPrefix ‘s’

where the fixed values are provided as literals and the undetermined values (in this case #1) represent parameters. A portion of the above document may be encoded by binding the parameter #1 to the literal ‘Envelope’.

In general, a template has a unique identifying name. The logical name used here is ‘StartElementPrefixedWithS record’ but the physical name is a previously agreed upon convention between the producer and consumer. For example, in the case of a binary record format, the producer and consumer may have agreed to represent the StartElementPrefixedWithS record by writing the integer value 87 into a record type field. The physical name allows the consumer to interpret the application of the template, such as that the integer value 87 indicates that the record type field is followed by a string field that encodes the value of the parameter #1.

However, it is not always feasible to predict the combinations of records that may be frequent. For example, XML documents 126 may be exchanged as part of a web service that receives a query expression and returns a series of query results whose value and format may both not be known in advance. The common combinations of records may even not be known until a portion of the data has been encoded.

In some embodiments, binary records 224 are defined for creating and using dynamic templates 210. A dynamic template encodes several information units in the document 206 using the structural definition of an exemplary instance while allowing other information units to be determined as part of the application (instantiation by invocation) of the template. The dynamic template is associated with a naming algorithm and an encoding algorithm. The naming algorithm and encoding algorithm generate a physical name (identifier 244) and a structure layout 214 for the application of the template in a fashion agreed upon between the producer (e.g., compressor 202) and consumer (decompressor 204). In this way, the producer and consumer only need to know ahead of time the algorithms and not the exact definitions of the templates.

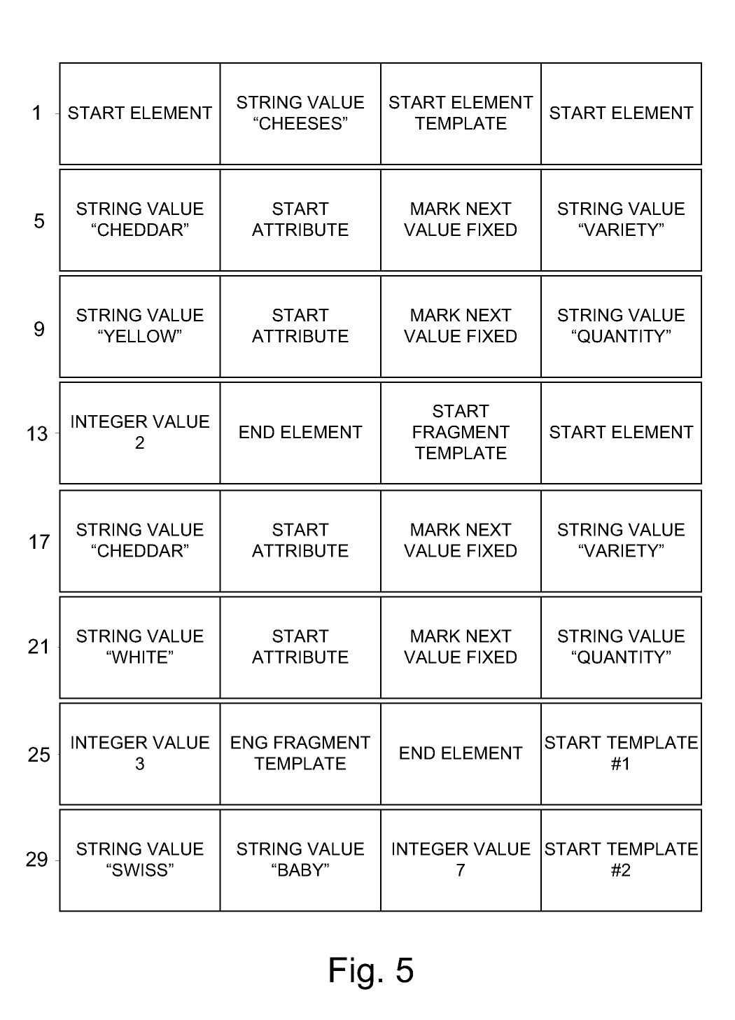

FIG. 4 illustrates a general data flow for serializing 402 and deserializing 414 XML documents with a binary XML format 410. The initial XML information set 416 exists logically but may not exist physically. That is, the information units 406 comprising the document need not exist in any physical location prior to serialization. The serialization 402 of an XML document produces associations 404 between information units 406 and binary data 408 in the form of binding template names to definitions. The lifetime of the association may be for a portion of a document, an entire document, or may even span multiple documents as agreed upon for the document format 410 used, by the producer and consumer. The serialized 402 document is transmitted 412 to the consumer, using a network 108 for example. The deserialization 414 of an XML document similarly may produce associations 404 between information units and binary data. The associations may be shared from serialization to deserialization but typically would probably be recreated as needed to avoid having to durably store and exchange them.

In particular, the serialization 402 may in some cases include compression 346 as taught here, deserialization 414 may include decompression 348, and the format 410 may be compatible with a document 206 having parameterized templates 210, according to the teachings provided herein.

In some embodiments, a process for template by example compression 346 by a producer includes the following. The producer nominates 322 a region of the document for production as a template. The region may be a well-formed document region (referred to here as an element template) or a non-well-formed region (referred to as a fragment template).

Continuing this process, the producer inserts 326 one or more records to the encoded document to effect the nomination. For example, a nomination may be indicated by a record 226 type for nominating the next complete element appearing in the document, a record 226 type for nominating the most recently seen complete element, a record 226 type for nominating a specific number of information units that follow or precede the nomination record, record 234 types for indicating the start and end of a group of information units, and the like.

Continuing this process, the producer annotates 328 literal information units within the nominated region, indicating whether the information unit in question is a fixed value 242 or a parameterized value 240. Literal information units 232 correspond to the content features of the XML document, such as integers, strings, dates, or other data types, as opposed to the structural features, such as element or attribute boundaries. For example, in the document region “<s:Envelope xmlns:s=“http://www.w3.org/2003/05/soap-envelope”></s:Envelope>” the opening and closing of an element would be structural features, while the name of the element “Envelope” and the namespace URI would be content features.

In particular, the annotation of literal information units may be indicated by a record 230 type for marking the next one or more literal information units as fixed values, a record 230 type for marking the next one or more literal information unit as parameter values, a record 230 type for marking the previous one or more literal information units as fixed values, a record 230 type for marking the previous one or more literal information unit as parameter value, a record 230 type for setting the default disposition of all literal information units within the template, or a record type 230 for marking a literal information unit and simultaneously performing an action (for example, a ‘FixedStringValue’ record type that both provides 340 a literal information unit and marks 328 it).

Continuing this process, the producer adds the nominated region to a collection 236 such as a table of template definitions, with an identifier generated 312 by running the naming algorithm. Some examples of naming algorithm mechanisms 248 include a successor function that generates a sequence of unique integer values (for example, 1, 2, 3, . . . ), a hash function that operates on one or more information units from the document to generate a unique name of fixed length (for example, running the MD5 hash algorithm on the template structure layout), and a user-defined identifier provided as a field of the nomination record 226.

Continuing this process, the producer records 342, 344 the structure layout, fixed information units, and the positions of parameter information units to the template definition. The producer adds (inserts 326) one or more records 228 to the encoded document 206 invoking the recorded template. The template invocation 238 specifies the name (identifier 244) of the template previously generated using the naming algorithm and supplies the zero or more parameter values 240 using a structure defined by the encoding algorithm.

In one embodiment the encoding algorithm sets the parameter value types 222 to those used in the exemplary instance (nominated region), to more efficiently encode the parameters. For example, assume the exemplary instance marked a string information unit as a first parameter value and an integer information unit as a second parameter value; templates were identified using integer values; and, the identifier of this template was the integer value 1. Then the encoding algorithm may define an invocation 238 as the record sequence: [invoke template record type] 1 [string length] [string value] [integer value]

In another embodiment the encoding algorithm might not set the parameter value types. Using the same example, the encoding algorithm may define an invocation as the record sequence: [invoke template record type] 1 [data type record] [first parameter content] [data type record] [second parameter content] where a data type record indicates the type of the subsequent parameter content and each parameter content is a structure layout defined by the data type.

In some embodiments, templates 210 may be composed from other templates by nesting nominated regions or by invoking a previously recorded template while inside a nominated region. An example of nesting is given below.

In some embodiments, a process for template by example decompression 348 by a consumer includes the following. The consumer receives 302 one or more records indicating the nomination of a document region. The consumer parses 304 the nominated document region to identify the template structure layout, fixed information units, and positions of parameter information units using the supplied annotations. The consumer adds the nominated region to its own collection 236 (e.g., table) of template definitions with an identifier 244 generated 312 by running the naming algorithm. The consumer records 342, 344 the structure layout, fixed information units, and the positions of parameter information units to the template definition. The consumer receives 302 one or more records 228 invoking the recorded template. The consumer expands 318 the invocation, by substituting for the template invocation one or more information units corresponding to the expansion of the invoked template with the parameter value information units.

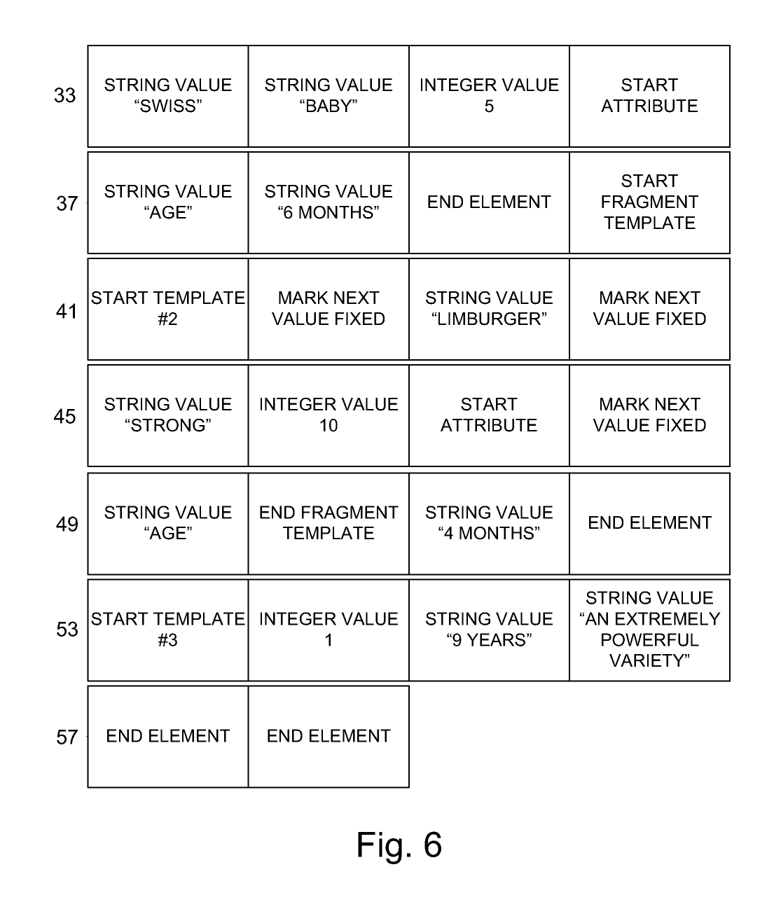

FIGS. 5 and 6 provide a more complete example of this process by specifying a portion of a protocol stream containing several template definitions and invocations. In this example, the naming algorithm assigns as template identifiers 244 increasing integers in the sequence 1, 2, 3. The encoding algorithm defines invocations 238 as a series of typed value records for each parameter value. Literal information units 232 default to being parameter values unless preceded by a record indicating that the subsequent literal is a fixed value.

Records 1-2 in the protocol stream start an XML element whose content will be a list of elements that describe an inventory and produce the deserialized partial output:

### <Cheeses>

Records 3-14 define an element template with three parameter values and produce the deserialized partial output:

### <Cheddar Variety=“Yellow” Quantity=2/>

The template table now contains template 1 of the templates illustrated below:

| Token | Template Value |
|---|---|
| 1 | <#1 Variety=#2 Quantity=#3></#1> |
| 2 | <#1 Variety=#2 Quantity=#3 |
| 3 | <Limburger Variety=”Strong” Quantity=#1 Age=#2 |

Records 15-27 define a fragment template with three parameter values and produce the deserialized partial output:

### <Cheddar Variety=“White” Quantity=3/>

The template table now contains templates 1 and 2 illustrated above. Note that the fragment and element templates are highly similar but differ by the element template ending the element as part of the template definition, and the fragment template permitting the addition of further content within the element.

Records 28-31 invoke the element template 1 and produce the deserialized partial output:

### <Swiss Variety=“Baby” Quantity=7/>

Records 32-39 invoke the fragment template 2, adding additional content to the fragment before completing the element to produce the deserialized partial output:

<Swiss Variety=“Baby” Quantity=5 Age=“6 months”/>

Records 40-52 define a fragment template with two parameter values by invoking the fragment template 2 and supplying parameter values along with additional content to the fragment to produce the deserialized partial output:

<Limburger Variety=“Strong” Quantity=10 Age=“4 months”/>

The template table now contains the templates 1, 2, and 3 illustrated above.

Records 53-57 invoke the fragment template 3, adding additional content to the fragment before completing the element to produce the deserialized partial output:

<Limburger Variety=“Strong” Quantity=1 Age=“9 years”> An extremely powerful variety.</Limburger>

Finally, record 58 closes the initial XML element to complete the deserialized output:

### </Cheeses>

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIG. 3 also help describe configured media, and help describe the operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A process of decompressing a sequence of previously created and compressed automatically parsable document(s) containing records, the process comprising the steps of:
receiving at least one record which nominates a region of a document as containing parameterized template information;
automatically parsing the nominated region, thereby extracting nominated region parsing results which include at least one parameter;
generating a template identifier;
recording a template by adding the nominated region parsing results to a template collection in a correspondence with the template identifier;
obtaining a first invocation record which contains a first invocation of the recorded template, the first invocation containing a recital of the template identifier and a first parameter value; and
obtaining a second invocation record which contains a second invocation of the recorded template, the second invocation containing a recital of the template identifier and a second parameter value which differs from the first parameter value.

2. The process of claim 1, wherein the process extracts nominated region parsing results which include a template structure layout and which also include at least one of the following: a fixed information unit, a position of a parameter information unit.

3. The process of claim 1, wherein the generating step generates the template identifier using at least one of the following: a successor function, a hash function, a user-defined identifier provided as a field of a nomination record.

4. The process of claim 1, wherein the sequence includes an XML document, and the receiving step receives at least one record which nominates a region of the XML document.

5. The process of claim 1, wherein the receiving step receives at least one record which nominates a region of the document which is recognizable by automatic parsing as being a fragment rather than being a well-formed region.

6. The process of claim 1, wherein the nominated region is located in the document after at least one initial uncompressed record of the document, and the process further comprises receiving at least one initial uncompressed record of the document before receiving the record(s) which nominate a region of the document as containing template information.

7. The process of claim 1, wherein the document invokes a first template from within a region defining a second template, in that the obtaining step obtains a record which (a) contains an invocation of the recorded template and (b) is also within a second nominated region.

8. The process of claim 1, further comprising inferring a parameter type from the recorded template.

9. A computer-readable non-transitory storage medium configured with data and with instructions that when executed by at least one processor causes the processor(s) to perform a process for compressing an XML document, the process comprising the steps of:
nominating a region of the XML document for production as a parameterized template;
inserting at least one record in the document to effect the nomination;
annotating at least one literal information unit within the nominated region;
generating a template identifier;
recording a parameterized template for the nominated region in a template collection, the parameterized template being recorded in correspondence with the template identifier; and
including at least two invocations of the recorded template in the XML document, in which at least two different parameter values are passed for a given parameter of the recorded template.

10. The configured medium of claim 9, wherein the nominating step nominates a region which is not well-formed under XML syntax.

11. The configured medium of claim 9, wherein the inserting step inserts at least one of the following in the document to effect the nomination:
a record nominating an upcoming complete XML element;
a record nominating a most recently completed XML element;
a record nominating a specific number of upcoming information units;
a record nominating a specific number of preceding information units;
a record specifying an information unit group start;
a record specifying an information unit group end.

12. The configured medium of claim 9, wherein the annotating step inserts at least one of the following in the document:
a record marking upcoming literal information unit(s) as fixed value(s);
a record marking upcoming literal information unit(s) as parameter value(s);
a record marking preceding literal information unit(s) as fixed value(s);
a record marking preceding literal information unit(s) as parameter value(s);
a record setting a default disposition of literal information unit(s) within the template as fixed value(s);
a record setting a default disposition of literal information unit(s) within the template as parameter value(s);
a record providing a literal information unit and also marking that unit as a fixed value;
a record providing a literal information unit and also marking that unit as a parameter value.

13. The configured medium of claim 9, wherein the generating step generates the template identifier using at least one of the following: a successor function, a hash function, a user-defined identifier.

14. The configured medium of claim 9, wherein the recording step records a template structure layout and which also records at least one of the following: a fixed information unit, a position of a parameter information unit.

15. The configured medium of claim 9, wherein the invocation including step includes in the XML document a record containing an invocation specifying the generated template identifier.

16. A computer system comprising:
a logical processor;
a memory in operable communication with the logical processor;
a template identifier generator;
a sequence of compressed automatically parsable document(s) residing in the memory and having records which include at least one template nomination record nominating a region of the records as a parameterized template, at least one literal information unit annotation record within the nominated region, at least one template invocation record for an invocation of the parameterized template, the template invocation record containing a template identifier which (a) is consistent with identifiers generated by the template identifier generator, and (b) identifies the template, and at least one record marking literal information unit(s) as parameter value(s) for the invocation of the parameterized template.

17. The system of claim 16, wherein the system further comprises at least one of the following:
a document compressor configured to generate the compressed automatically parsable document(s) in conjunction with the template identifier generator;
a document decompressor configured to decompress the compressed automatically parsable document(s) in conjunction with the template identifier generator.

18. The system of claim 16, wherein the sequence of compressed automatically parsable document(s) includes at least one of the following:
an inner nomination region nested within an outer nomination region;
an invocation of a first template within a nomination region of a second template.

19. The system of claim 16, wherein the sequence of compressed automatically parsable document(s) includes a nomination region which is not well-formed under a syntax with which the document(s) as a whole comply.

20. The system of claim 16, wherein the sequence of compressed automatically parsable document(s) includes a first document and a second document; the first document includes a nomination record nominating a parameterized template; and the second document includes a template invocation record invoking the template.
